(19) United States
(12) Patent Application Publication
(10) Pub. No.: US 2025/0276389 A1
(43) Pub. Date: Sep. 4, 2025

(54) SPRING-LOADED ARBOR FOR USE WITH A HOLE SAW

(71) Applicant: MASPBR, LLC, Hurricane, UT (US)

(72) Inventors: Jordan Alldredge, Washington, UT (US); Joseph Lund, Hurricane, UT (US)

(73) Assignee: MASPBR, LLC, Hurricane, UT (US)

(21) Appl. No.: 19/068,534

(22) Filed: Mar. 3, 2025

Related U.S. Application Data
(60) Provisional application No. 63/561,079, filed on Mar. 4, 2024.
(60) Provisional application No. 63/638,271, filed on Apr. 24, 2024.
(60) Provisional application No. 63/713,454, filed on Oct. 29, 2024.

(51) Int. Cl. B23B 51/04

(52) U.S. Cl. CPC B23B 51/0473

(57) ABSTRACT

An arbor for a hole saw has a shank having an internal chamber therein, a spring situated within the internal chamber, and a plunger configured to compress the spring, when under pressure, within the internal chamber, the plunger having a drill bit receiving slot. As a user applies force to the pilot drill bit extending from the plunger, the applied pressure forces the plunger into the internal chamber, compressing the spring. Once the pressure on the pilot drill bit is released, such as when the core is freed from surrounding material, the spring extends, forcing the plunger from the internal chamber and thereby forcing the core from the surrounding material and/or hole saw. In some examples, a release mechanism may be included to control the release of the plunger from the internal chamber.

### CROSS-REFERENCE TO RELATED APPLICATIONS

This application claims the benefit of U.S. Provisional Application Ser. No. 63/561,079, filed on Mar. 4, 2024, and further claims the benefit of U.S. Provisional Application Ser. No. 63/638,271, filed on Apr. 24, 2024, and further claims the benefit of U.S. Provisional Application Ser. No. 63/713,454, filed on Oct. 29, 2024, all of which are incorporated herein by reference.

### TECHNICAL FIELD

The present disclosure relates to arbors for use with hole saws.

### BACKGROUND

A hole saw is an attachment or accessory for a drill. The shank that is received into the chuck of the drill is commonly referred to as an arbor, with the saw portion being cylindrical at a distal end of the shank. Arbored hole saws often also refer to a hole saw that includes a pilot drill bit that extends beyond the end of the hole saw to aid in centering the hole saw and to provide stability to the hole saw during use. Hole saws are typically used for cutting holes into studs, drywall, or other materials so that pipes, conduit, cables, etc. can pass therethrough. While hole saws are efficient, they often leave the core (the material being removed) lodged within its surroundings, or within the hole saw itself. As a result, users are required to pry the core free to expose the hole from the surroundings, or must pry it from the hole saw before the saw may once again be used. This process is time consuming, especially when a user needs to cut many holes as part of a construction project.

Some attempts have been made to solve this problem, including arbors that attempt to push the core out after drilling. However, these attempts fall short as they typically require additional steps, such as manual actuation of the ejection mechanism, and the mechanisms are prone to malfunction or breaking due to the number and configuration of parts.

Accordingly, there remains a need for an arbored hole saw that is capable of ejecting the core with minimal or no additional steps from a user and that requires little maintenance to maintain. The present disclosure seeks to solve these and other problems.

### SUMMARY OF EXAMPLE EMBODIMENTS

In some embodiments, an arbor for a hole saw comprises a shank having an internal chamber therein, a spring situated within the internal chamber, and a plunger configured to compress the spring, when under pressure, within the internal chamber, the plunger comprising a drill bit receiving slot. As a user applies force to the pilot drill bit extending from the plunger, the applied pressure forces the plunger into the internal chamber, compressing the spring. Once the pressure on the pilot drill bit is released, the spring extends, forcing the plunger from the internal chamber and thereby forcing the core from the surrounding material and/or hole saw.

In some embodiments, the spring remains compressed until released by a user via a release mechanism, whereupon the plunger is then forced, by the extending spring, from the chamber, which subsequently forces the core from the surrounding material and/or hole saw.

### BRIEF DESCRIPTION OF THE DRAWINGS

FIG. 1 illustrates a front, left perspective view of an arbor for a hole saw;

FIG. 2 illustrates a front, left perspective view of the internal arrangement of components of an arbor for a hole saw;

FIG. 3 illustrates a cross-section of a left side elevation view of an arbor for a hole saw;

FIG. 4 illustrates a cross-section of a top plan view of an arbor for a hole saw;

FIG. 5 illustrates a left, side exploded perspective view of an arbor for a hole saw;

FIG. 6 illustrates a left, side elevation view of the internal arrangement of components of an arbor for a hole saw; and

FIG. 7 illustrates a left, side elevation view of the internal arrangement of components of an arbor for a hole saw.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an arbored hole saw that is capable of ejecting the core with minimal or no additional steps by a user and that requires little maintenance. The arbor for a hole saw disclosed herein solves these and other problems.

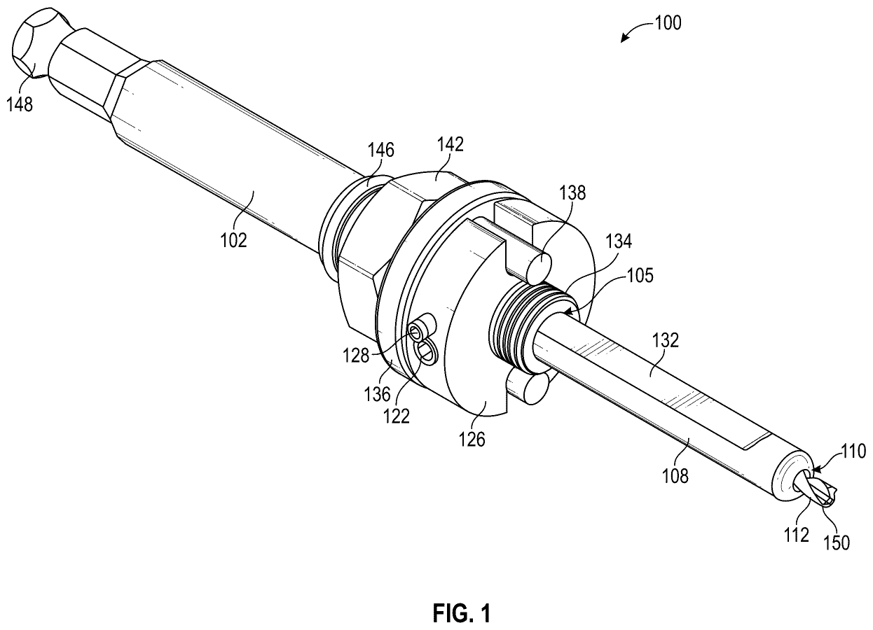

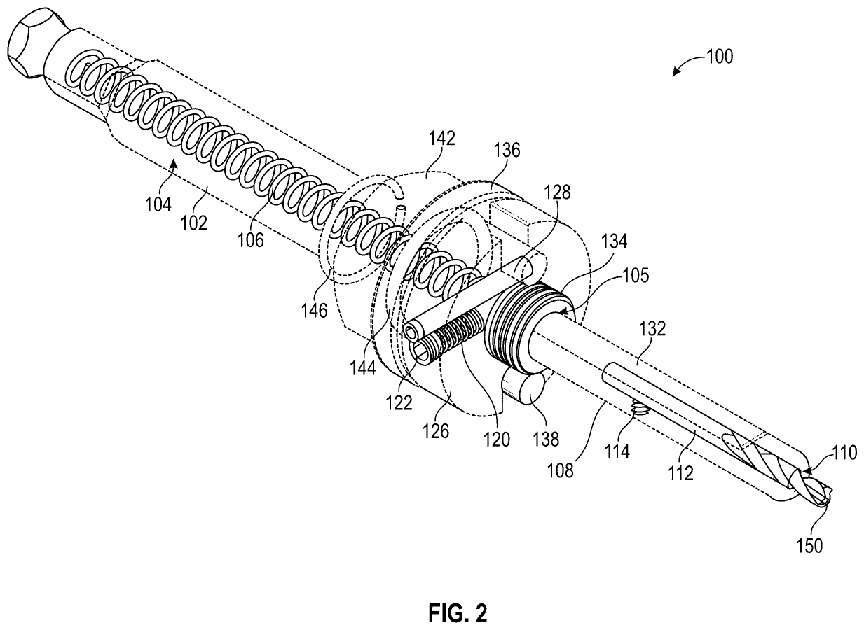

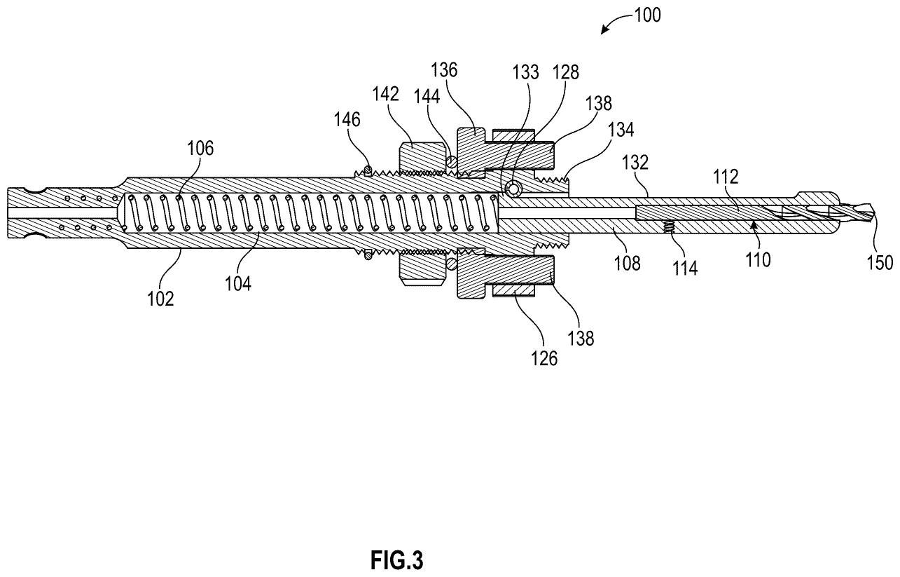

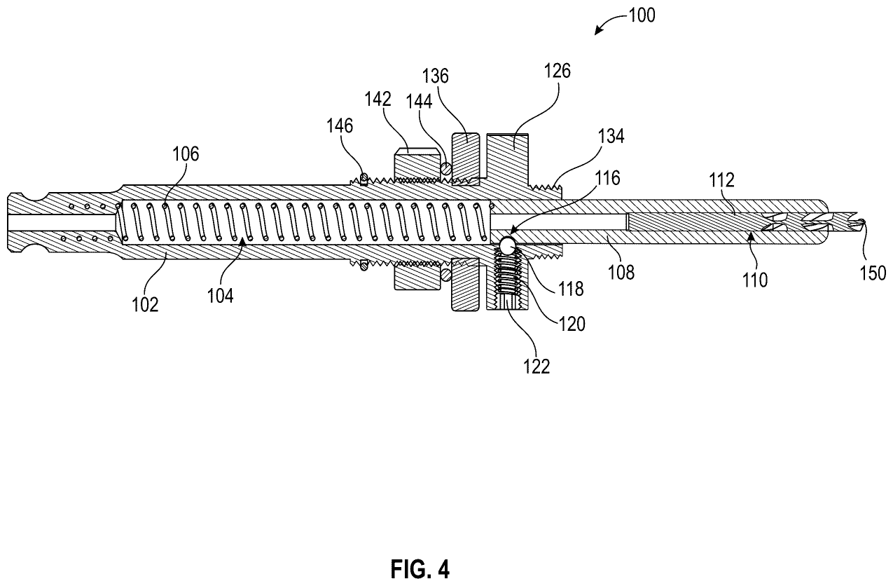

Referring to FIGS. 1-5, in some embodiments, an arbor 100 for a hole saw comprises a shank 102 having an internal chamber 104 therein, a spring 106 situated within the internal chamber 104, and a plunger 108 configured to compress the spring 106 via chamber opening 105, when under pressure, within the internal chamber 104, the plunger 108 comprising a drill bit receiving slot 110. In its most basic usage, as a user applies force to a tip 150 of a pilot drill bit 112 extending from the plunger 108, the applied pressure forces the plunger 108 into the internal chamber 104, compressing the spring 106. Once the pressure on the pilot drill bit 112 is released, such as when the core is cut free of its surroundings, the spring 106 extends, forcing the plunger 108 from the internal chamber 104 and thereby forcing the core from the surrounding material and/or hole saw.

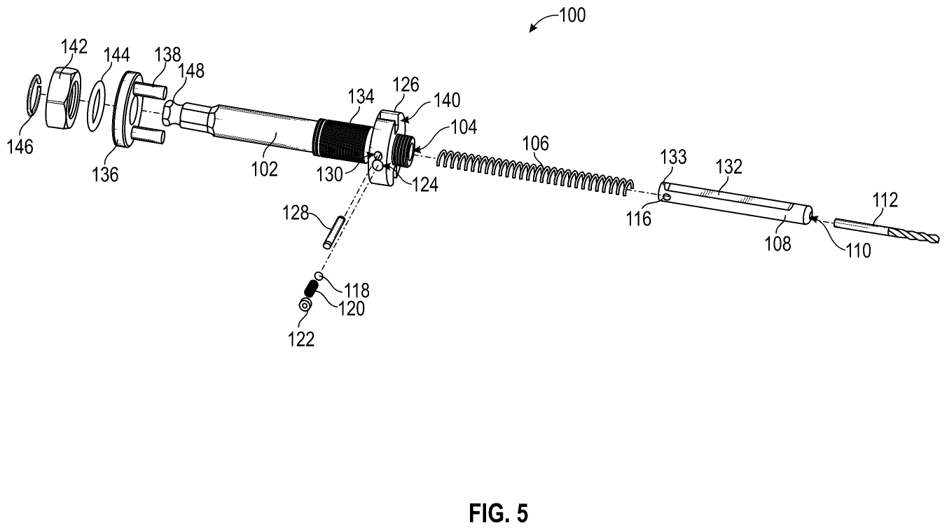

In some embodiments, the pilot drill bit 112 is secured within the drill bit receiving slot 110 of the plunger 108 using a locking screw 114. As such, if the pilot drill bit 112 is dull or breaks, a user may easily replace the pilot drill bit 112 by loosening the locking screw 114, removing and replacing the pilot drill bit 112, and re-tightening the locking screw 114. Further, to ensure that the plunger 108 does not prematurely enter the internal chamber 104, the plunger 108 may comprise an indentation 116 (best seen in FIG. 5) that is configured to receive a ball bearing 118 which is held in the indentation 116 via a detent spring 120 and lock screw 122, which are receivable through bearing slot 124 of positioning ring 126 on the shank 102. Due to the pressure of the ball bearing 118 in the indentation 116, a predetermined amount of force must be applied to the pilot drill bit 112 and plunger 108 to cause the detent spring 120 to compress enough to allow the ball bearing 118 to exit the indentation 116, thereby allowing the plunger 108 to begin compressing the spring 106.

Further, to ensure that the plunger 108 does not rotate within the internal chamber 104 or fully exit therefrom, a roll pin 128 may be insertable perpendicular to the internal chamber 104 through roll pin slot 130 of positioning ring 126. The plunger 108 may be “keyed” using a flat edge 132 that extends longitudinally along a portion of the plunger 108. The roll pin 128 then rolls along the flat edge 132 as the plunger 108 retracts into and extends out of the internal chamber 104. As a result, the flat edge 132 and roll pin 128 prevent rotation of the plunger 108. Additionally, because the flat edge 132 only extends along a portion of the length of the plunger 108, an end protrusion 133 prevents the plunger 108 from fully exiting the internal chamber 104 by being blocked by the roll pin 128.

As shown, it will be appreciated that the positioning ring 126 may be coupled to the shank 102 via a threaded end 134. With the positioning ring 126 in the desired position, a lock ring 136 may be coupled thereto. The lock ring 136 comprises one or more hole saw coupling protrusions 138 (also known as drive pins) that are received through corresponding apertures 140 on the positioning ring 126. The lock ring 136 is secured in position via a locking nut 142. An O-ring 144 may be interposed between the locking nut 142 and the lock ring 136 to prevent binding. Lastly, a snap ring 146 may be secured behind the locking nut 142 to prevent unwanted loosening of the locking nut 142 during use.

Accordingly, in one method of assembly, a user will insert a desired pilot drill bit 112 into the drill bit receiving slot 110 and secure the desired pilot drill bit 112 to the plunger 108 via the locking screw 114. A hole saw may then be coupled to the threaded end 134 (e.g., collar screw) of the shank 102, and will align the apertures 140 of the positioning ring 126 with the corresponding apertures in the hole saw, wherein the tip 150 of the pilot drill bit 112 extends beyond the front cutting edge of the hole saw. Once aligned, the lock ring 136 may be coupled to the positioning ring 126 with the coupling protrusions 138 passing through the apertures 140 and into the hole saw. The O-ring 144 may then be placed to abut the lock ring 136, with the locking nut 142 being threaded against the O-ring 144. Once secured, the snap ring 146 may abut the locking nut 142. A drill connection end 148 is then coupled to a drill for use.

In one method of use, a user will place the tip 150 against a surface to be cut. Because of the ball bearing 118 placing pressure on the plunger 108, the plunger 108 does not begin to compress the spring 106, allowing a user to begin a pilot hole in the surface. Once the pilot hole is started and/or drilled, a user may apply additional force by pushing on the drill, which force overcomes the detent spring 120 and thereby allows the plunger 108 to begin compressing the spring 106, allowing the hole saw to contact the material and begin cutting until the hole saw passes through the material. Once a hole is achieved and the pressure on the spring 106 is relieved as a result of the core being freed from the surrounding material, the spring 106 extends, forcing the plunger 108 from the internal chamber 104, thereby forcing the core of material to be ejected from the surrounding surface and/or the hole saw itself. As a result, a user is able to more efficiently drill holes without needing to pry the core out, increasing productivity.

While the above embodiments generally describe the spring 106 extending once pressure is relieved (i.e., the hole is fully cut), it may be beneficial, in some embodiments, to control the ejection of the core. Accordingly, in some embodiments, an arbor for a hole saw may comprise a release mechanism.

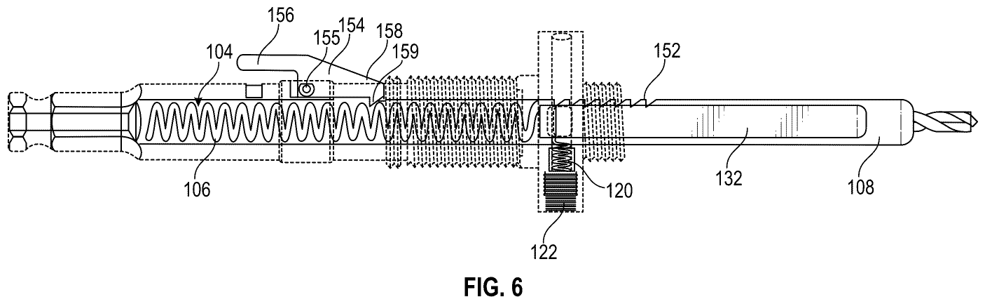

For example, referring to FIG. 6, the plunger 108 may further comprise one or more notches 152 that engage with a locking lever 154. The locking lever 154 may be spring biased so as to maintain engagement with a respective notch 152. The notches 152 may be sloped so as to allow movement in a first direction, compressing the spring 106, but prohibiting movement in the opposite direction (allowing the spring to extend). As a result, the plunger 108 remains within the internal chamber 104 until the locking lever 154 is disengaged from the respective notch 152. For example, the locking lever 154 may pivot, such as on a pivot pin 155, allowing a user to force a first end 156 downward, which pivots the second end 158 upward, thereby releasing a tooth 159 of the second end 158 from engagement with the notches 152 (the notches 152 configured as a rack along a portion of the length of the plunger 108. The spring 106 then freely extends, forcing the plunger 108 from the internal chamber 104, which thereby forces the core from the surrounding material and/or hole saw.

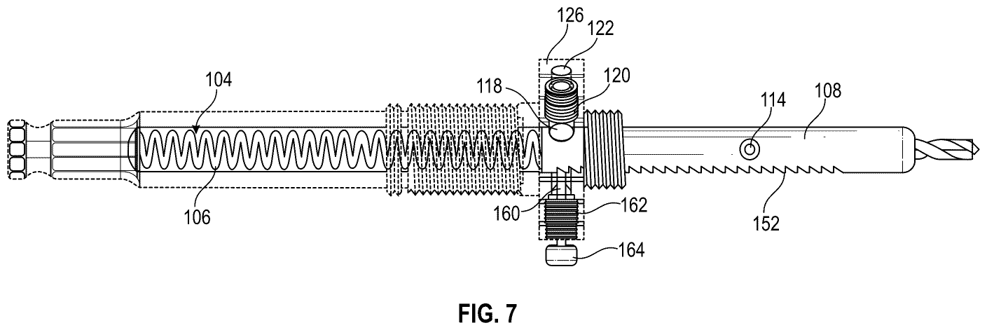

Similarly, FIG. 7 illustrates an embodiment wherein a spring-biased release pin 160 is used to engage the one or more notches 152 of the plunger 108. For example, the release pin 160 may pass through positioning ring 126 to engage the one or more notches 152, which may be configured as a rack when a plurality of notches 152 are present, on the plunger 108. A spring 162 may bias the release pin 160 against the plunger 108 to engage the one or more notches 152. As the previous embodiment, the notches 152 may be shaped so as to allow movement of the plunger 108 in a first direction, compressing the spring 106 within the internal chamber 104, with the release pin 160 prohibiting movement of the plunger 108 in the opposite, extended direction. Once a user has finished drilling a hole, the release pin 160 may be manually actuated (e.g., pulled outwardly) via a knob 164, compressing the spring 162 and thereby withdrawing the release pin 160 from engagement with the notches 152 on plunger 108. As a result, the spring 106 extends, forcing the plunger 108 from within the internal chamber 104, which thereby forces the core from the surrounding material and/or the hole saw.

While various release mechanisms were described and shown in FIGS. 7-8, it will be appreciated that other release mechanisms may be used without departing herefrom, including detent mechanisms, lever mechanisms, spring-loaded buttons, and other mechanisms capable of securing the plunger 108 within the internal chamber 104 until released by a user.

Therefore, it will be appreciated from the foregoing that the arbor 100 for a hole saw as disclosed herein solves the need for hole saw that is capable of ejecting the core with minimal to no additional steps by a user and that requires little maintenance. Further, in some embodiments, the arbor for a hole saw disclosed herein also provides for a controlled release of the core with minimal steps.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An arbor for a hole saw, comprising:
a shank comprising a drill connection end, a threaded end with a chamber opening, and an internal chamber;
a spring situated within the internal chamber; and
a plunger configured to slide through the chamber opening and within the chamber;
wherein when the plunger is under pressure, the plunger compresses the spring within the internal chamber; and
wherein when the plunger is not under pressure, the spring extends, ejecting the plunger from within the internal chamber.

2. The arbor for the hole saw of claim 1, wherein the plunger further comprises a drill bit receiving slot.

3. The arbor for the hole saw of claim 1, wherein the plunger further comprises a flat edge to engage with a roll pin to prevent rotation of the plunger within the internal chamber.

4. The arbor for the hole saw of claim 1, further comprising a positioning ring.

5. The arbor for the hole saw of claim 1, further comprising a lock ring.

6. The arbor for the hole saw of claim 5, wherein the lock ring comprises one or more hole saw coupling protrusions.

7. The arbor for the hole saw of claim 1, wherein the plunger comprises an indentation to receive a ball bearing, the ball bearing applying lateral force on the plunger via a detent spring.

8. The arbor for the hole saw of claim 1, wherein the plunger comprises one or more notches.

9. The arbor for the hole saw of claim 8, wherein the shank comprises a lever configured to selectively engage with the one or more notches of the plunger.

10. The arbor for the hole saw of claim 8, further comprising a release pin configured to selectively engage with the one or more notches of the plunger.

11. An arbor for a hole saw, comprising:
a shank comprising a drill connection end, a threaded end with a chamber opening, and an internal chamber;
a spring situated within the internal chamber;
a plunger configured to slide through the chamber opening and within the chamber, the plunger comprising a flat edge along a portion of its length;
a positioning ring couplable to the shank;
a lock ring abutting the positioning ring, the lock ring comprising one or more hole saw coupling protrusions;
a locking nut configured to secure the lock ring in position on the shank;
a roll pin configured to pass through the shank and internal chamber, the roll pin configured to abut the flat edge of the plunger to prevent rotation of the plunger and configured to selectively engage an end protrusion to prevent the plunger from fully exiting the internal chamber;
wherein when the plunger is under pressure, the plunger compresses the spring within the internal chamber; and
wherein when the plunger is not under pressure, the spring extends, ejecting the plunger from within the internal chamber until stopped by the roll pin abutting the end protrusion.

12. The arbor for the hole saw of claim 11, wherein the plunger further comprises a drill bit receiving slot.

13. The arbor for the hole saw of claim 11, wherein the plunger comprises an indentation to receive a ball bearing, the ball bearing applying lateral force on the plunger via a detent spring.

14. The arbor for the hole saw of claim 11, wherein the plunger comprises one or more notches.

15. The arbor for the hole saw of claim 14, wherein the shank comprises a lever configured to selectively engage with the one or more notches of the plunger.

16. The arbor for the hole saw of claim 14, further comprising a release pin configured to selectively engage with the one or more notches of the plunger.

17. A method of using an arbor for a hole saw, the method comprising:
placing a drill bit against a surface to commence drilling;
applying pressure to the drill bit until the hole saw comes into contact with the surface and begins cutting the surface;
as the hole saw advances through the surface, the drill bit applies pressure to a plunger, forcing the plunger into an internal chamber and compressing a spring;
once a hole is fully cut through the surface, the pressure on the drill bit and plunger ceases, allowing the spring within the internal chamber to extend, thereby forcing the plunger from within the internal chamber; and
as the plunger extends from the internal chamber, it forces a core of material from the hole and from the hole saw.

18. The method of claim 17, wherein the plunger comprises one or more notches configured to retain the plunger within the internal chamber until a release mechanism is actuated by a user.

19. The method of claim 18, wherein the user actuates the release mechanism by toggling a lever.

20. The method of claim 18, wherein the user actuates the release mechanism by pulling a release pin.
